(19) United States
(12) Patent Application Publication
(10) Pub. No.: US 2006/0212328 A1
(43) Pub. Date: Sep. 21, 2006

(54) Integrated market research management and optimization system

(76) Inventors: Scott Hoffmire, Boynton Beach, FL (US); Judy Hoffmire, Boynton Beach, FL (US); Michael Rollosson, Memphis, TN (US); Judy Lynn Smith, Germantown, TN (US); Kenneth Wolff, Rockville, MD (US)

Correspondence Address: Raymond Jones;Suite 550 - PMB 5537, 11921 Freedom Drive, Reston, VA, 20190, US

(21) Appl. No.: 11/079,885

(22) Filed: Mar. 15, 2005

(51) Int. Cl. G05B 19/418

(52) U.S. Cl. 705/8

(57) ABSTRACT

A market research management and optimization system includes a plurality of geographically dispersed market research centers and a centralized computer management system, accessible via a single client interface, for coordinating the plurality of geographically dispersed market research centers and human capital requirements in order to conduct research exercises in the market research centers. The centralized computer management system includes a database for storing facility information for the geographically dispersed market research centers, and human capital data associated with research participants. A scheduling engine is used to reserve and coordinate the research exercises in the geographically dispersed market research centers, and for reserving and coordinating lodging requirements for research exercise participants. An optimization system communicates with the database and scheduling engine for selecting one or more of the geographically dispersed market research centers and a subset of research volunteers based on criteria provided by a corporate research sponsor. A centralized payment processing system facilitates financial transactions and settlements associated with the scheduling engine.

### BACKGROUND OF THE INVENTION

1. Field of the Invention

The present invention relates generally to market research systems, and more particularly to a centralized market research management and optimization system to facilitate market research activities for all participants, including the research sponsoring company, the market research center staff, and the research volunteers.

2. Description of the Related Art

Market research activities include both quantitative and qualitative studies. Quantitative research generally involves large random samples, and tends to focus on answers to objective questions, as in surveys, or observations of actual behaviors, such as number of clicks on a web site. If carefully designed and executed, the main advantage of quantitative research is that the research sponsoring company can make predictions with a high degree of probability. Quantitative research is good for predicting such things as market size, customer demographics, and price vs. features trade-offs.

Quantitative studies have certain drawbacks, however, including the cost and time to implement the research process. Also, quantitative approaches force the customer into certain pre-conceived categories or structured response segments, compared to more open-ended and interactive approaches. The researchers are the ones who select the questions and potential responses, which do not allow for the capture of additional data from respondents that were not anticipated by the researchers.

Qualitative research, on the other hand, is open-ended and interactive by its very nature. Qualitative research includes focus groups and one-on-one in-depth interviews with the targeted market segment. Telephone interviews, online focus groups and online bulletin boards are also effective, but each of these approaches lacks the ability to gauge important non-verbal cues and interest. The qualitative approach enables the researcher to view the product through the customer's own eyes, using the customer's language and terms, which helps the researcher translate features into customer benefits. This direct and unstructured knowledge collection can impact product design, product positioning, feature sets, and marketing/advertising strategies.

Drawbacks of the qualitative approach are that sampling does not permit scientific prediction, and the results are dependent on the skill of the research consultant/moderator to elicit substantive responses. Moreover, since qualitative market research methodologies generally require face-to-face contact with members of targeted market segments (“focus groups”) in multiple geographic locations, the research study quickly becomes a logistical nightmare. Currently, securing suitable facilities in multiple locations, securing lodging for traveling research staff members and company sponsors, identifying and scheduling the participants in market research from targeted customer segments, and producing documents from the data collected during the research exercise, are all independent activities that must be coordinated precisely for a successful exercise. A significant amount of man-hours are expended just in this logistical support effort, and if not coordinated correctly, could lead to an ineffective research exercise and a waste of both personnel and financial resources.

What is needed therefore, is a centralized market research management and optimization system that will coordinate facilities management and human capital management, and optimize these tasks using a single client interface and central computerized management system.

### SUMMARY OF THE INVENTION

To overcome the above described and other disadvantages of the prior art, embodiments of the invention described herein provide for a nationwide network of market research centers linked by a centralized management system featuring combined facilities and lodging reservations, integrated research volunteer recruitment and management functions, and business meeting and document production capabilities.

In accordance with one aspect of the invention, there is provided a market research management and optimization system, comprising a plurality of geographically dispersed market research centers and a centralized computer management system, accessible via a single client interface, for coordinating the plurality of geographically dispersed market research centers and human capital requirements in order to efficiently conduct research exercises in the market research centers. The centralized computer management system includes a database for storing facility information for the geographically dispersed market research centers, and human capital data associated with research participants; a scheduling engine for reserving and coordinating the research exercises in the geographically dispersed market research centers, and for reserving and coordinating lodging requirements for research exercise participants; optimization means communicating with the database and scheduling engine for selecting one or more of the geographically dispersed market research centers and a subset of research participants based on criteria provided by a corporate research sponsor; and a centralized payment processing means for facilitating financial transactions and settlements associated with the scheduling engine.

Preferably, each of the geographically dispersed market research centers is resident in a host facility, wherein the host facility is a hotel. The scheduling engine can therefore reserve and coordinate market research center availability, lodging and meal requirements at the host hotel facility through a single client interface.

The research exercise participants using the scheduling engine comprise market research center staff, corporate research sponsors and research volunteers, and the corporate research sponsors can access the scheduling engine though a client interface without gaining access to the remainder of the centralized computer management system functions.

Another embodiment of the invention includes a research participant recruiting and management system for identifying, classifying and thereafter scheduling the research volunteers. The research volunteers are recruited in various geographical markets, are profiled using socio-demographic criteria, and are targeted for a particular research exercise based on the socio-demographic criteria and the radius or distance (“geo-spatial data”) to one of the geographically dispersed market research centers. Optimizing the socio-demographic and geo-spatial characteristics associated with the target market enhances participation rates by the research volunteers.

Another embodiment of the invention includes means for collecting from, and distributing data within and among the geographically dispersed market research centers. The data production and data distribution may be performed by a stand-alone third party provider affiliated with the geographically dispersed market research center, or conducted at the market research center itself.

In another embodiment, the invention includes a market research center staff certification system for setting uniform product delivery guidelines across all of the geographically dispersed market research centers. The invention may also include a market research center construction and certification system for setting uniform construction guidelines and minimum feature specifications across all of the geographically dispersed market research centers.

Preferably, the invention further includes a centralized marketing and sales force wherein the market research centers are marketed nationally to corporate research sponsors.

### BRIEF DESCRIPTION OF THE DRAWINGS

The above objects and other advantages of the present invention will become more apparent by describing in detail the preferred embodiments thereof with reference to the attached drawings in which:

FIG. 1 is a schematic diagram of certain functional components of an embodiment of the integrated market research management and optimization system;

FIG. 2 is a more detailed schematic diagram of the graphical user interface of the system of FIG. 1;

FIG. 3 is a more detailed schematic diagram of the market research facilities components of the system in FIG. 1;

FIG. 4 is a detailed schematic diagram of the centralized sales force component of the system in FIG. 1;

FIG. 5 is a detailed schematic diagram of the market research recruiting and management system illustrated in FIG. 1; and

FIG. 6 is an exemplary embodiment of certain database inputs and optimized outputs of the invention.

### DESCRIPTION OF PREFERRED EMBODIMENTS

The present invention will now be described more fully with reference to the accompanying drawings, in which preferred embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Broadly described, an embodiment of the invention provides for a nationwide database of market research volunteers (i.e., focus group volunteers) that serves as the basis for a nationwide network of market research centers linked by a centralized management system using a single client interface. While nationwide coverage provides certain advantages, the centralized management system of the present invention is not limited thereto, and can be used with one or more market research centers, whether at a local, state, regional, national, or international level.

The centralized management system incorporates an affiliated scheduling engine for coordinating the execution of multi-location research projects. An integrated research participant recruiting and management system builds socio-demographic profiles of the nationwide database of market research volunteers. By optimizing the socio-demographic and geo-spatial profiles, a research consultant can select the optimum market location for conducting market research and for attaining recruitment efficiencies within those selected markets. Management and production of documents, stimuli media and other data collected during the research exercises are supported by a single client interface within the centralized management system.

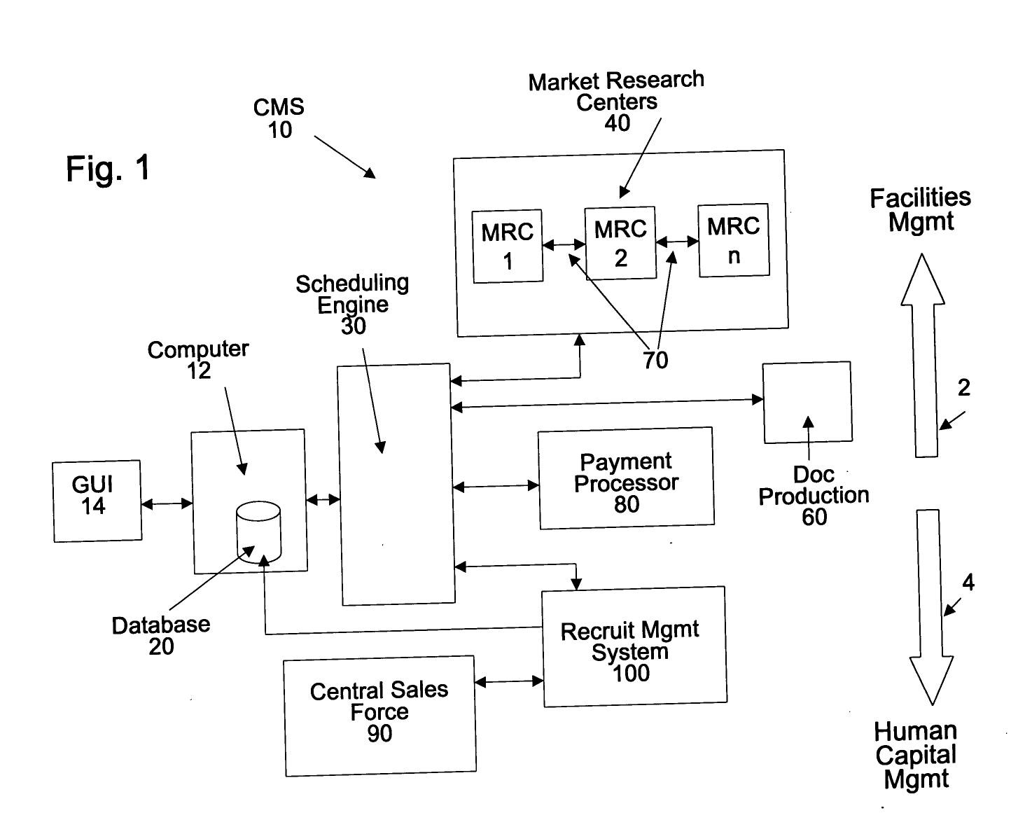

Qualitative market research requires precise coordination and scheduling of two main components—human capital (e.g., corporate research sponsors, research center/consultant staff and research volunteers) and facilities (e.g., research center scheduling, lodging requirements, meals, etc.). FIG. 1 provides a top-level functional view of an embodiment of the centralized and integrated market research management and optimization system 10 of the invention, which facilitates the management, coordination and scheduling of the facilities and human capital. The arrow 2 in FIG. 1 broadly illustrates the facilities management tasks and activities, and the arrow 4 in FIG. 1 broadly illustrates the human capital tasks and activities. It is understood that the description in FIG. 1 is simply for illustration purposes and to facilitate describing embodiments of the invention. The invention may be implemented as discrete systems with separate databases for facilities and human capital interacting with each other, or a single database system supporting all functions.

As shown in FIG. 1, the centralized management system (CMS) 10 incorporates a conventional computer system 12 containing at least one database 20. The computer system is preferably accessed by an easy-to-use graphical user interface 14. Any number of hardware/software configurations may be utilized in the present invention. For example, the computer system 12 may be hosted at a central site at the research consultant's facility, at the corporate sponsor's facility, at distributed sites, or be web-based. The computer system may consist of one or more dedicated servers and their associated databases 20. The system of the present invention can be designed to run on any existing or future operating system, including Windows, Linux, Macintosh, Solaris or the like.

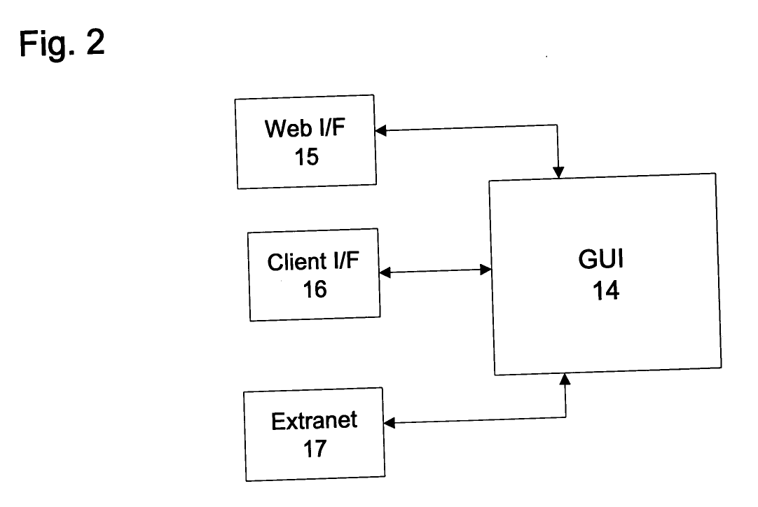

As shown in FIG. 2, to facilitate using the present invention in any dedicated or distributed computing environment, the graphical user interface 14 may have a web-based interface 15 or a standard client/workstation interface 16, and preferably offers both. This would allow data input from any computer in the networked system running the CMS 10, or any computer that could interface with the CMS 10 via the Internet. Still further, certain population groups, such as the corporate research sponsors, could be granted access to certain portions of the CMS 10, either through the web-based interface 15 and controlled by permissions and security levels, or through a different discrete web-based extranet interface 17 with only the relevant content and functionality presented.

This would allow corporate research sponsors to access certain portions of the CMS 10 (e.g., the scheduling engine 30 to make their own hotel reservations as discussed further below), without gaining access to other proprietary parts of the CMS 10. Of course, proper access codes, encryption, VPNs, and other security measures may be employed on any of the interfaces 15, 16 or 17 to ensure data integrity.

Returning again to FIG. 1, a scheduling/reservations engine 30 interfaces with the computer system 12 and database 20 for coordinating the availability and execution of multi-location research projects at one or more geographically dispersed market research centers 40. Geographically dispersed as used herein simply means separate research exercises are being conducted in separate rooms, but not necessarily in separate locations. For example, research exercises may be conducted in multiple separate rooms within a single office suite, in multiple separate buildings containing a market research center 40, or multiple market research centers 40 in different cities, states or countries. The research exercises may be conducted consecutively or simultaneously. All of these scenarios would benefit from the centralized coordination of activities as set forth in the present invention.

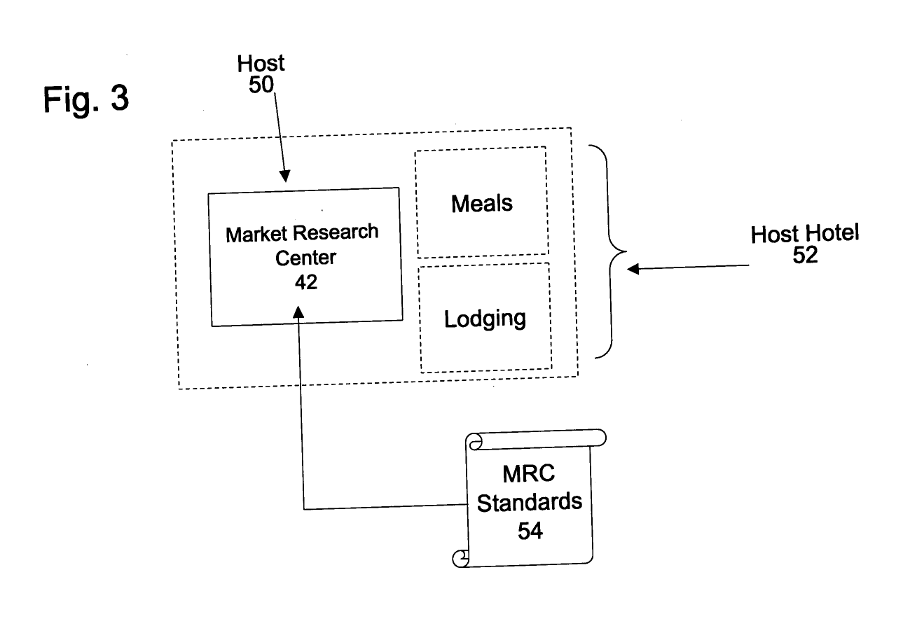

As shown in FIG. 3, the market research centers 40 may be stand-alone facilities 42, which are very expensive to build and maintain, or are owned/leased as part of a larger office park, retail plaza or other commercial office space facility 50. As one of ordinary skill in the art would understand, the quality, style and availability of office space varies from region to region. Therefore, even for multi-unit research centers 40, the variability from region to region results in a lack of certainty and repeatability in the size, style, and features of each market research center 40 in the research center network. Accordingly, the market research centers 40 of the present invention are preferably built in hotel chains 52 throughout the country, wherein individual hotels in the hotel chain 52 act as the host facility for one of the geographically dispersed market research centers 40. In addition to hotel chains 52, certain convention centers and other facilities capable of providing lodging and meals are contemplated in the present invention.

The pairing of the market research center 40 and the hotel chain 52 as the host facility 50 results in numerous synergistic advantages. The hotel chain 52 properties are already subject to certain minimum chain-wide standards as far construction, layout, location, lodging and food guidelines. Hotel chains 52 generally engage in background research efforts to locate their properties in convenient locations with sufficient traffic flow, while appealing to certain defined demographics. Building and/or renting a market research center 40 in a hotel chain 52 thus ensures a minimum level of visibility, convenience, predictability and repeatedly throughout the research center network that is not presently available in the market.

In addition to a suitable space or meeting area to conduct the research exercise, one of the logistical challenges in conducting either single or multi-location research exercises across the country is providing meals to the corporate research sponsors, the research center/consultant staff, and the research volunteers during the research exercise. Another logistical challenge is finding suitable lodging accommodations and lodging availability near the market research center 40 for the corporate sponsor's personnel, and perhaps the research center/consultant staff as well. Since the market research centers 40 are housed in the hotel 52, they may or may not be manned everyday by the research center staff. Therefore, the research center staff may need to travel to different locations to conduct a research exercise, depending on the particular goals of the research exercise and the criteria provided by the corporate sponsor.

Because the hotel chains 52 provide on site food service options and lodging accommodations, all primary and supporting activities associated with a successful market research exercise can be accommodated in a single location. Even with multi-location research projects, meals can be provided on site to the market research volunteers, the research center staff and the corporate sponsors. Also, the corporate sponsors and research center staff can stay right in the hotel 52 that is housing the market research center 40.

In the past, a research exercise coordinator was left to separately ascertain a research center's availability, the travel and lodging accommodations for the participants, and the meal requirements for the participants, resulting in a significant waste of personnel and monetary resources. With the scheduling engine 30 of the present invention, however, all these activities are handled in one place, using a single client interface 14, resulting in a more efficient process. Further monetary and personnel resource efficiencies are achieved when the market research center 40 is located at a hotel 52 or similar facility that offers meals and lodging, because all of these logistical functions occur at a single facility, facilitating planning and execution of the research exercise.

Returning to FIG. 1, because market research exercises generate significant amounts of data that must be evaluated, there is a requirement to manage and produce documents and other audio and video media for distribution among the research centers, usually under very tight deadlines. Therefore, it is preferable that some sort of document and media production facility 60 be located at the market research center 40, or be affiliated with the market research center 40 and be located reasonably close to the market research center 40. Such affiliated document and media production facilities 60 could range from local copy stores, to national copy chains such as FedEx/Kinko's, to regional or national office supply stores such as Staples, Office Depot or OfficeMax. Document production facility 60 availability can also be scheduled and reserved through the central scheduling/reservations engine 30.

FIG. 1 also depicts a conventional communications system 70 for distributing voice and data among the market research centers 40. The communications system 70 is preferably accessible to both the research center staff and the corporate research sponsors, again with appropriate access codes and permission levels.

A centralized payment processing system 80 interfaces with the scheduling/reservation engine 30 to provide a one-stop payment processing solution for all the facilities management tasks described above, whether research facility rental, lodging, food, document production, or other tasks associated with conducting the research exercise. Any of the many conventional credit card, debit card, or check clearance payment systems may be utilized as part of the central payment processor 80. In addition to a one-stop payment system, the centralized payment processing system 80 can provide a single invoice for the research exercise with all the charges itemized to facilitate subsequent accounting and billing tasks.

While one can reasonably be assured of the quality of structural and comfort features inherent in a regional or national hotel chain 52, there is no such assurance or certification in the market research center area. Existing market research centers (even multi-center facilities) vary in structural design, features and quality, making it difficult for a research consultant to conduct an exercise in an unknown facility with any degree of predictability and repeatedly. Accordingly, a preferable feature of the invention is the building and deployment of a network of market research centers 40 with minimum construction guidelines and feature specifications, thereby providing a threshold certification of predictability and repeatedly throughout the CMS 10.

Preferably each market research center 40 will contain a minimum set of repeatable standards 54 (see FIG. 3), much the same way national hotel and restaurant chains ensure predictability in their individual user experiences regardless of the property location. For example, each market research center 40 could provide suitable audio and visual recording equipment, suitable telephone, internet and video conferencing transmission equipment, a separate waiting/lobby area, a suitably sized area for conducting the research group activities with comfortable and sufficient seating, a suitably sized area set aside for the corporate sponsor to meet, work, and view the volunteers through a one-way mirror, and suitable areas for refreshments, restrooms and other comfort controls such as heating and air conditioning. The rooms should be sufficiently soundproofed, both the walls and ceiling, and be handicap accessible. It is understood that the minimum set of repeatable standards 54 may encompass more or less elements within the scope of this invention. What is important is that any user of a market research center 40 in the CMS 10 is assured of some minimum level of services and features.

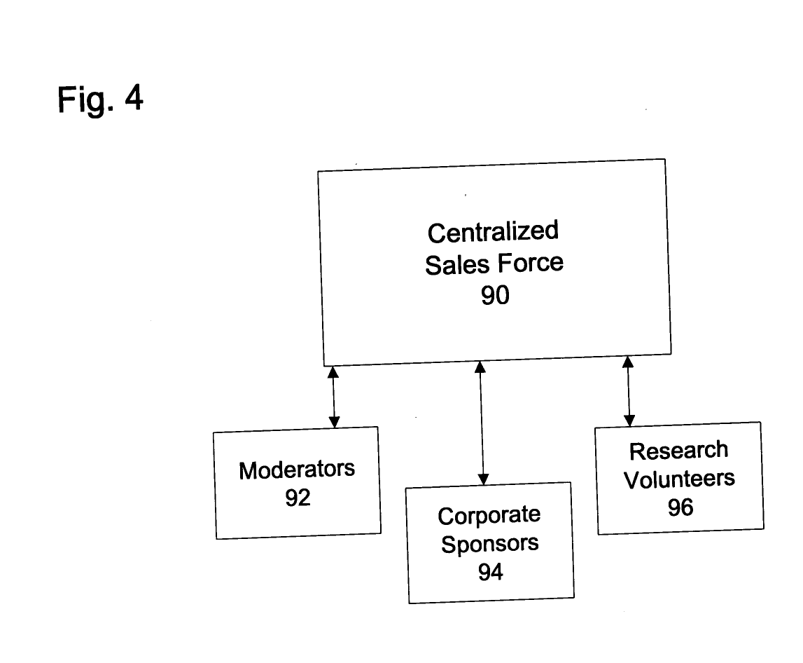

The CMS 10 of the present invention also provides for centralized management and coordination of the human capital element of any research exercise. As shown in FIG. 1, a centralized sales force 90 is employed. The centralized sales force 90 may be local or regional in nature, but it is preferably national in scope to better realize the benefits of the present invention. As shown in FIG. 4, the centralized sales force 90 is responsible for recruiting market research center moderators 92, recruiting corporate research sponsors 94 interested in conducting market research, and recruiting market research volunteers 96, among other functions. The centralized sales force 90 may be a single division, or comprise multiple divisions that focuses on one or more of the recruiting segments for moderators 92, corporate sponsors 94 or market research volunteers 96. Regardless of the organizational hierarchy, the sales force 90 will preferably interface with a market research recruiting and management system 100.

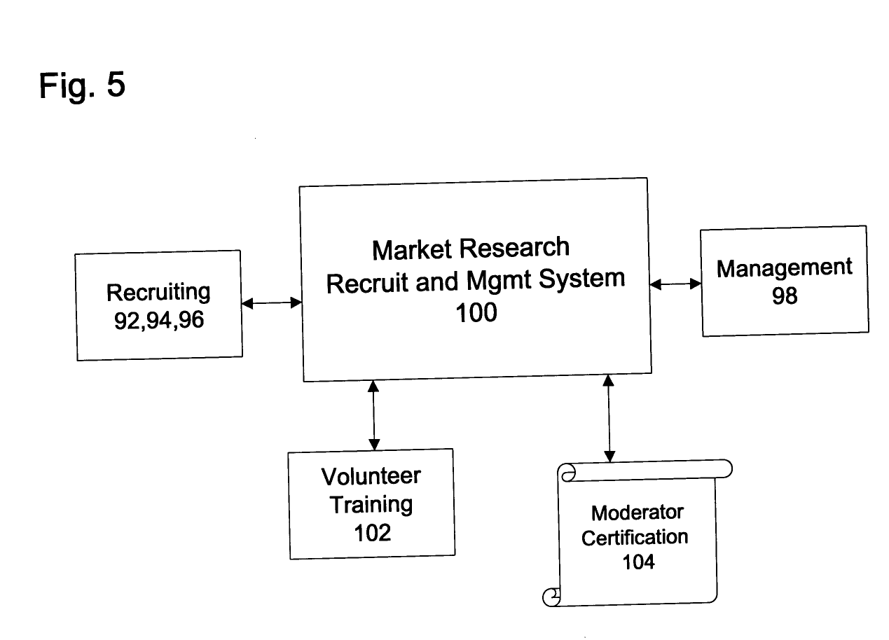

FIG. 5 illustrates the main functional features of the market research recruiting and management system 100. As the name implies, the main functions are recruitment (e.g., centralized recruitment of moderators 92, corporate sponsors 94 and market research volunteers 96), and management 98 of those recruitment efforts. The management efforts 98 would include, but are not limited to, classifying the volunteers 96 according to socio-demographic and geo-spatial criteria and recording that information in database 20. It could also include scheduling the moderators 92 and research volunteers 96 for a particular exercise. The recruiting and management system 100 also includes research volunteer training functions 102 and moderator certification functions 104.

Obviously solicitation of quality corporate sponsors 94 for research is important, because the corporation is ultimately the one paying for the services offered by a research consultant. By having a national sales force 90, the research consultant is able to target the larger, multi-location corporations who provide products to a regional or nationwide (or international) audience. These types of corporations are most likely to need market research and feedback from multiple markets segments and demographic areas (what sells one way in Maine may not sell the same way in California), and thus the CMS 10 is ideal to coordinate multiple location market research centers 40, whether statewide, regional, national or international.

Another important recruitment function is that of the market research volunteers 96 in the targeted demographic. By having an organization with multiple, predictable and certified market research center 40 locations, the demographics around each of the geographically dispersed market research centers 40 can be determined with reasonable accuracy and entered in the database 20. Because the research center locations are already known, this allows the sales force 90 to more accurately identify, and later solicit and schedule, the targeted demographic in a specific geographic area. The research volunteers 96 should receive some minimal level of training or instruction 102 on the exercise dynamics prior to the exercise to ensure the best possible research exercise session, without swaying the research outcome. Such volunteer training 102 can be accomplished over the phone, via email, or in person before the exercise begins. In addition to the sales force 90, the research center staff may also participate in volunteer training 102.

The third important recruitment effort is moderator recruitment 92, because the moderator's role is crucial to a successful research exercise. Focus group market moderators 92 seek to tap emotional and unconscious motivations not amenable to the structured questions of conventional survey research. The interaction among market research volunteers 96 brings out differing perspectives through the language that is used by the volunteers 96. People get caught up in the spirit of group discussion and may reveal more than they would in the more formal interview setting. As the volunteers 96 ask questions of each other, new avenues of exploration are opened. In discussions, multiple meanings are revealed as different volunteers 96 interpret topics of discussions in different ways. Interaction is the key to successful focus groups, as the volunteers draw each other out, leading to new ideas or approaches.

The role of the market research moderator 92 is to facilitate, not dominate the discussion. The moderator 92 encourages the participation of everyone and seeks to limit the domination of discussion by a few volunteers 96. The moderator 92 may also offer prompting questions to elicit further information. The moderator 92 may also seek to return the conversation to the topic at hand, when it is apparent that the discussion is taking an unwanted tack. Finally, the moderator 92 may take notes or record the conversation of the group, and must also be sensitive to omissions, choice of words, non-verbal communications, expressions of emotion, energy levels, and the roles played by the volunteers.

Accordingly, another part of the market research recruitment and management system 100 is moderator training/certification. Preferably, the program results in a threshold of proficiency suitable for granting a moderator certification 104 recognized throughout the central management system 10.

While the convenience and time savings inherent in the centralized management and coordination of both the facilities and human capital elements are benefits of the present invention, another benefit is optimization of both the facilities and human capital elements to ensure the most constructive result for the corporate sponsor. The key is for the research consultant to identify qualified market research volunteers 96 with the required socio-demographic profiles, within a certain radius or distance (“geo-spatial profile”) of a market research center 40, as dictated by the corporate sponsor 94. The market research center's 40 “show rate” or “fill rate” of qualified and responsive volunteers 96 is important to the quality and success of the research exercise. If twenty-five volunteers are identified and only five show up, the quality of the research exercise will suffer.

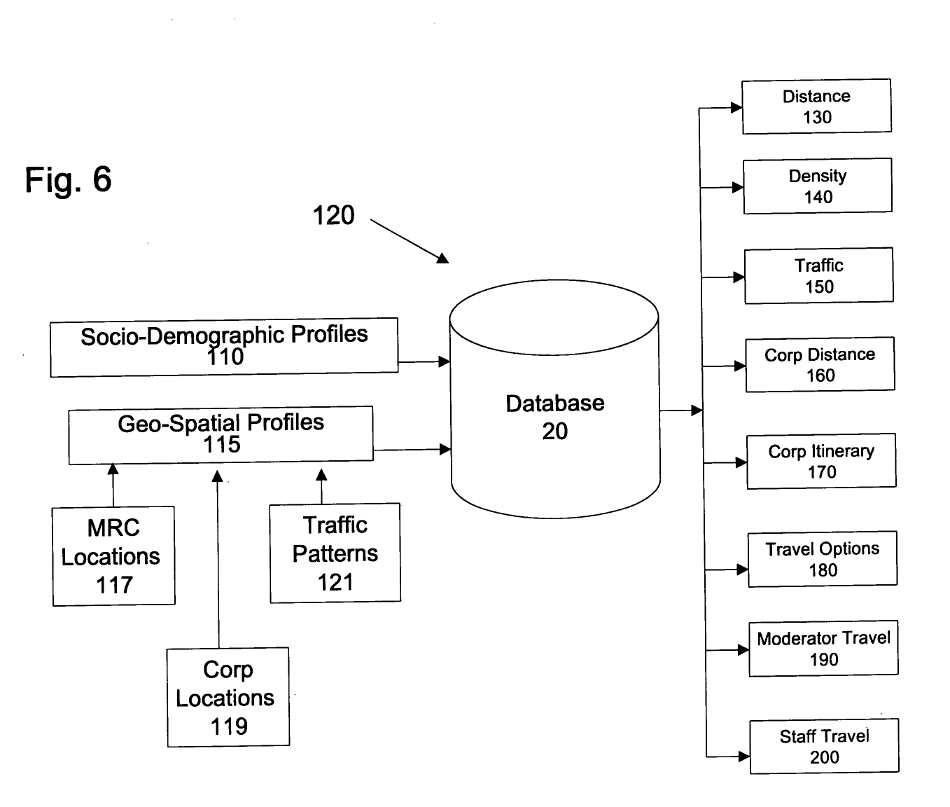

FIG. 6 is an exemplary embodiment of certain database inputs and optimized outputs of the present invention. As described above, the key to a constructive research exercise is to efficiently identify qualified market research volunteers 96 with the required socio-demographic profile 110 as dictated by the corporate sponsor 94, within a certain distance (geo-spatial profile 115) of the most convenient market research center 40. Optimizing these socio-demographic 110 and geo-spatial 115 profiles is a feature of the present invention, and is achieved by an optimization means 120 employing a suitable database schema and query structure.

In an exemplary optimization scenario, a corporate sponsor 94 would request a focus group with certain socio-demographic criteria 110 to test market, for example, a new marketing campaign for a five-bladed razor. The socio-demographic criteria 110 specified by the corporate sponsor 94 could be, for example, 25-35 years old, physically active, single, male, with a college education, and making at least $35,000 per year. The corporate sponsor, located in Memphis, wants to have focus groups in Boston, New York, Miami, Chicago, Austin, Denver, Los Angeles and Seattle.

In the past, the conventional market research consultant had to locate and separately coordinate disparate research facilities in each of the eight cities, make lodging reservations in the cities for the corporate sponsor and research staff, and ensure suitable meals were available for all participants. Also, while broad demographic data is available by zip code or other segmentations, it is difficult for the research consultant's sales/recruiting staff to hone in on the exact socio-demographic criteria and recruit quality research volunteers 96, because there is no preexisting database of robust geo-spatial data for a nationwide market research center network.

However, with the nationwide market research center network of the present invention, and the optimization means 120, the research consultant could query the database 20 and receive an optimum result based on the pre-defined socio-demographic 110 and geo-spatial 115 profiles contained therein.

In the exemplary embodiment of FIG. 6, the primary search criteria for the database 20 would typically be the market research volunteer socio-demographic profiles 110, and the geo-spatial profiles 115 around the market research center locations 117, and may perhaps include the corporate sponsor locations 119. The geo-spatial profiles 115 may comprise discrete rings at designated radii from the market research center 40 with the demographic make-up identified by age, race, hobbies, interests, etc. The particular concentration of like demographic attributes can also be determined, thereby providing better visibility for highly concentrated demographic “pockets”. Such pocket density data would facilitate recruitment efforts. For example, if a certain age range of targeted young males were concentrated in a residential condominium community, or military base, within two miles of a market research center 40, such information could be targeted by the sales force 90, thereby reducing the recruiting time for attaining the most qualified individuals because the number of individuals satisfying the criteria is greater in those areas. In other words, the probability of reaching the targeted demographic in those dense areas is greater, thereby making the recruiting process more efficient. Traffic patterns 121 around the market research center 40 are also important, since the “show rate” or “fill rate” of qualified and responsive volunteers 96 may be enhanced or adversely affected depending on the time of day, traffic patters, and the like.

Since the database 20 is already populated with such information linking research volunteer socio-demographics 110 and their geo-spatial 115 orientation to the market research center locations 117, a myriad of optimization results and statistical market research center site selections may be output from the database 20.

For example, the following optimized location/demographic outputs in FIG. 6 can be achieved based on the corporate sponsor locations 119, market research volunteer socio-demographic profiles 110, market research center locations 117, and geo-spatial profiles 115. The most optimum market research center 40 can be based on the distance 130 from the market research center 40 of the targeted demographic, the density 140 of the targeted demographic near the market research center 40, or the travel times and traffic patterns 150 in and around the market research center 40.

The most optimum market research center 40 can also be based on the distance from the market research center 40 and the corporate sponsors' personnel participating in the surveys 160, the projected travel itinerary for the corporate sponsors' personnel when conducting multiple location research exercises 170 (e.g., 5 sites in 5 days), and the number of travel options 180 available to the corporate sponsors' personnel to get to and from the market research center(s) 40. The most optimum market research center 40 can also be based on the distance from the market research center 40 and the moderator 92 participating in the research exercises 190, or the projected travel itinerary for the research consultant's staff 200.

The most optimum market research center 40 can also be based on factors in addition to socio-demographic 110 or geo-spatial 115 criteria. For example, one criterion could be to increase the use rate or fill rate (of meal and lodging services) at a particular host hotel 52, where the other criteria for selection of a market research center site are relatively equal. Perhaps the hotel chain 52 has excess availability during certain days of the week, or certain times of the year. Where certain market research centers 40 provide equal demographic attributes, the scale may tip to the underperforming hotel chain 52 (or market research center 40).

Therefore, the optimization means 120 operates to select one or more of the geographically dispersed market research centers 40 and a subset of research volunteers 96 based on criteria provided by a corporate research sponsor 94. Of course, more than one of these optimization techniques described above can be combined and modified to achieve the desired results.

Also, to facilitate an understanding of the large amounts of data that is presented, it is preferable to use data visualization techniques (generating graphics, charts, color rings, etc.) to represent the data associated with the many database attributes such as demographic rings, demographic density, market research center 40 locations, corporate locations, itineraries, traffic patterns and the like.

Regardless of the optimized result, with the present invention, all of these recruitment, selection, optimization, management, and scheduling tasks are carried out through a single user interface 14, in conjunction with the scheduling engine 30.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. A market research management and optimization system, comprising:
a plurality of geographically dispersed market research centers;
a centralized computer management system accessible via a single client interface for coordinating the plurality of geographically dispersed market research centers and human capital requirements in order to conduct research exercises in the market research centers, the centralized computer management system comprising;
a database for storing facility information for the geographically dispersed market research centers, and human capital data associated with research participants;
a scheduling engine for reserving and coordinating the research exercises in the geographically dispersed market research centers, and for reserving and coordinating lodging requirements for research exercise participants;
optimization means communicating with the database and scheduling engine for selecting one or more of the geographically dispersed market research centers and a subset of the research participants based on criteria provided by a corporate research sponsor; and
a centralized payment processing means for facilitating financial transactions and settlements associated with the scheduling engine.

2. The system of claim 1, wherein the research exercise participants using the scheduling engine comprise market research center staff, corporate research sponsors and research volunteers.

3. The system of claim 2, wherein the corporate research sponsors can access the scheduling engine though an extranet interface without gaining access to the remainder of centralized computer management system functions.

4. The system of claim 2, wherein research center scheduling and set-up, timing, research participant identification, special project needs, accounting, billing and payment are managed via a web-based client interface from any computer in the geographically dispersed market research centers.

5. The system of claim 1, further comprising a research participant recruiting and management system for identifying and classifying the research participants.

6. The system of claim 5, wherein the research participants are research volunteers and are recruited in various geographical markets, are profiled using socio-demographic criteria, and are scheduled for a particular research exercise based on the socio-demographic criteria and the distance to one of the geographically dispersed market research centers.

7. The system of claim 1, further comprising means for collecting from, and distributing data within and among the geographically dispersed market research centers.

8. The system of claim 7, wherein data production and data distribution is performed by a stand-alone third party provider affiliated with the geographically dispersed market research center.

9. The system of claim 1, wherein each of the geographically dispersed market research centers is resident in a host facility, wherein the host facility is a hotel.

10. The system of claim 9, wherein the scheduling engine reserves and coordinates the market research center availability and lodging requirements at the host facility.

11. The system of claim 1, wherein the criteria comprise socio-demographic criteria within a certain radius of one of the plurality of the geographically dispersed market research centers.

12. The system of claim 1, wherein the criteria comprise geo-spatial criteria that probabilistically minimizes elapsed recruitment time.

13. The system of claim 1, further comprising a communication system wherein required client communications for multiple geographic locations are organized through a single computerized communications engine.

14. The system of claim 1, further comprising a market research center staff certification system for setting uniform product delivery guidelines across all of the geographically dispersed market research centers.

15. The system of claim 1, further comprising a market research center construction and certification system for setting uniform construction guidelines and minimum feature specifications across all of the geographically dispersed market research centers.

16. The system of claim 1, further comprising a centralized marketing and sales system wherein the market research centers are marketed nationally to corporate research sponsors.
